(19) United States
(12) Patent Application Publication
(10) Pub. No.: US 2020/0284078 A1
(43) Pub. Date: Sep. 10, 2020

(54) ADJUSTABLE HINGE ASSEMBLY FOR AUTOMOBILE TAILGATE

(71) Applicant: VOLVO CAR CORPORATION, Göteborg (SE)

(72) Inventors: Johan PRIM, Sätila (SE); Hanna BÖRJESSON, Göteborg (SE)

(21) Appl. No.: 16/296,912

(22) Filed: Mar. 8, 2019

(51) Int. Cl. E05D 7/04; E05D 3/02; B62D 65/06; E05D 5/02; E05D 5/04

(52) U.S. Cl. CPC E05D 7/0415; E05D 3/02; B62D 65/06; E05D 5/0207; E05D 5/043; E05Y 2900/546; E05Y 2600/54; E05D 2007/0492; E05Y 2600/12; E05Y 2600/31; E05Y 2600/51; E05Y 2600/526; E05Y 2900/532

(57) ABSTRACT

This invention relates to an adjustable hinge assembly for an automobile tailgate. The hinge assembly contains a first mounting plate configured for mounting to an automobile body, a first hinge member attached to the first mounting plate, a second mounting plate configured for mounting to a tailgate, and a second hinge member attached to the second mounting plate. The first and second hinge members are hingedly connected. Adjustment screws are positioned on the hinge assembly to adjust the position of the first hinge member on the first mounting plate in the x- and y-direction. An adjustment screw is positioned on the hinge assembly to adjust the position of the second hinge on the second mounting plate in the z-direction.

### TECHNICAL FIELD

This invention relates to an adjustable hinge assembly for an automobile tailgate. In particular, the hinge assembly contains adjustment screws for adjusting the position of the tailgate relative to the automobile body after installation of the tailgate.

### BACKGROUND ART

Automobile tailgates are used to close the rear opening of an automobile. Typically, the tailgate is mounted to the automobile's body by a hinge which allows the tailgate to open or close by rotation on the hinge. The hinge usually contains a folding mechanism having a first bracket attached to the body of the automobile and a second bracket attached to the tailgate. The tailgate may be opened or closed by the action of the hinge.

During assembly or operation of the automobile the hinge or the tailgate may become misaligned which leads to poor positioning, poor seal, and poor gap and flush control of the tailgate. Current hinge designs require complicated and time consuming steps, such as loosening of the hinge from the automobile body and/or the tailgate, to adjust and realign the hinge for proper alignment of the tailgate. The loosening of the hinge leads to uncontrolled and unwieldy handling of the tailgate.

Accordingly, there is a need for a hinge assembly that allows for simple, quick, and controlled adjustment of the tailgate hinge.

### SUMMARY OF THE INVENTION

An aspect of the present invention provides an adjustable hinge assembly for an automobile tailgate. The hinge assembly contains a first mounting plate configured for mounting to an automobile body, a first hinge member attached to the first mounting plate, a second mounting plate configured for mounting to a tailgate, and a second hinge member attached to the second mounting plate. The first and second hinge members are hingely connected. Adjustment screws are positioned on the hinge assembly to adjust the position of the first hinge member on the first mounting plate in the x- and y-direction. An adjustment screw is positioned on the hinge assembly to adjust the position of the second hinge member on the second mounting plate in the z-direction. When assembled and in a closed position (a position of the hinge to keep the tailgate closed), the x-, y-, and z-directions are approximately orthogonal to each other. By being able to adjust the positions of the first and second hinge members on their respective mounting plates, the position of the tailgate on the automobile body can be adjusted for proper fitting after installation.

Another aspect of the present invention provides an automobile where a tailgate is attached to the automobile body by at least one of the adjustable hinge assembly described above.

Methods for making and using the different aspects of the present invention are also provided.

Other aspects of the invention, including apparatuses, devices, kits, processes, and the like which constitute part of the invention, will become more apparent upon reading the following detailed description of the exemplary embodiments.

### BRIEF DESCRIPTION OF THE DRAWINGS

The foregoing background and summary, as well as the following detailed description, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings

FIG. 1 is a drawing showing a first perspective view of a hinge assembly according to the present invention;

FIG. 2 is a drawing showing a second perspective view of the hinge assembly;

FIG. 3 is a drawing showing a third perspective view of the hinge assembly;

FIG. 4 is a drawing showing a perspective view of the first mounting plate;

FIG. 5 is a drawing showing a plan view of the first mounting plate shown in FIG. 4;

FIG. 6 is a drawing showing a perspective view of the first hinge member;

FIG. 7 is a drawing showing a perspective view of the second mounting plate;

FIG. 8 is a drawing showing a plan view of the second mounting plate shown in FIG. 7;

FIG. 9 is a drawing showing a perspective view of the second hinge member; and

FIG. 10 is a drawing showing a close up view of an assembled adjustment screw.

### DESCRIPTION OF EMBODIMENTS

The exemplary embodiment of the present invention will now be described with the reference to accompanying drawings. The following description of the preferred embodiment is merely exemplary in nature and is in no way intended to limit the invention, its application, or uses.

For purposes of the following description, certain terminology is used in the following description for convenience only and is not limiting. The characterizations of various components and orientations described herein as being “front,” “back,” “vertical,” “horizontal,” “upright,” “right,” ‘left,” “side,” “top,” “bottom,” “above,” “below,” or the like designate directions in the drawings to which reference is made and are relative characterizations only based upon the particular position or orientation of a given component as illustrated. These terms shall not be regarded as limiting the invention. The words “downward” and “upward” refer to position in a vertical direction relative to a geometric center of the apparatus of the present invention and designated parts thereof. The terminology includes the words above specifically mentioned, derivatives thereof and words of similar import.

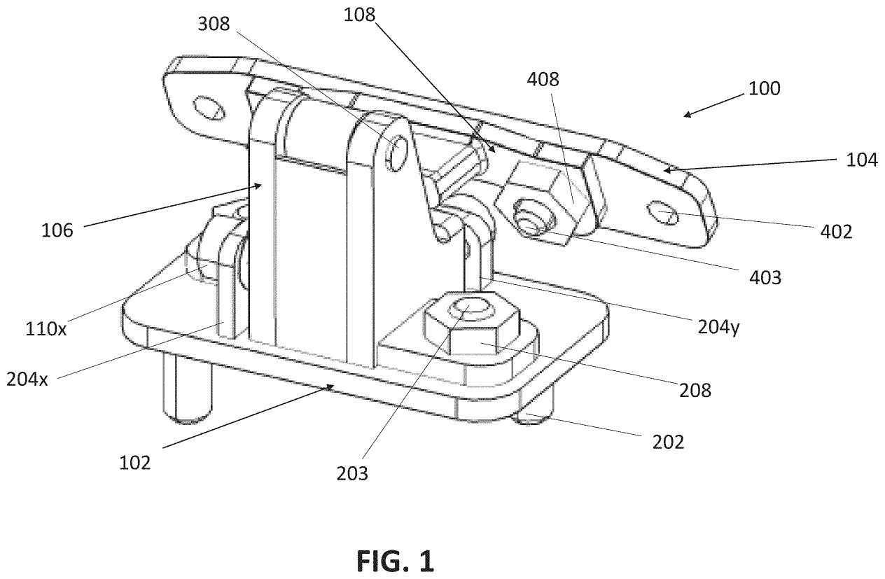

Referring to FIGS. 1-3, a hinge assembly 100 is designed and configured to be easily adjustable after the mounting of a tailgate to an automobile body. The hinge assembly 100 contains a first mounting plate 102, a second mounting plate 104, a first hinge member 106, and a second hinge member 108. The first mounting plate 102 is configured to mount to the body of the automobile; and the second mounting plate 104 is configured to mount to the tailgate. That said, one skilled in the art would understand that it is possible to reverse the hinge assembly 100 so that the first mounting plate 102 and the first hinge member 106 are mounted to the tailgate, and the second mounting plate 103 and the second hinge member 108 are mounted to the body of the automobile. The first hinge member 106 is mounted on the first mounting plate 102. As discussed in further detail below, the mounting of the first hinge member 106 on the first mounting plate 102 can be adjustable in a first direction x (x-direction) and a second direction y (y-direction), where the first and second directions are approximately orthogonal to each other and are parallel to the plane of the first mounting plate 102. The second hinge member 108 is mounted on the second mounting plate 104. As discussed in further detail below, the mounting of the second hinge member 108 on the second mounting plate 104 can be adjustable in a third direction z (z-direction) parallel to the plane of the second mounting plate 104. The first and second hinge members 106 and 108 are hingely connected to provide a hinge therebetween. In the closed position of the hinge assembly, the x-, y-, and z-directions are approximately orthogonal to each other.

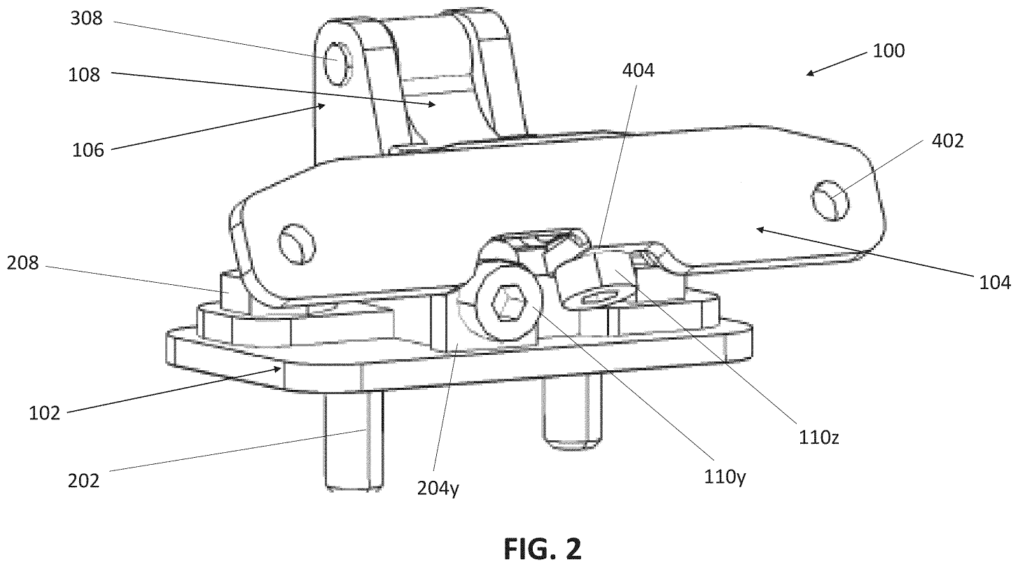

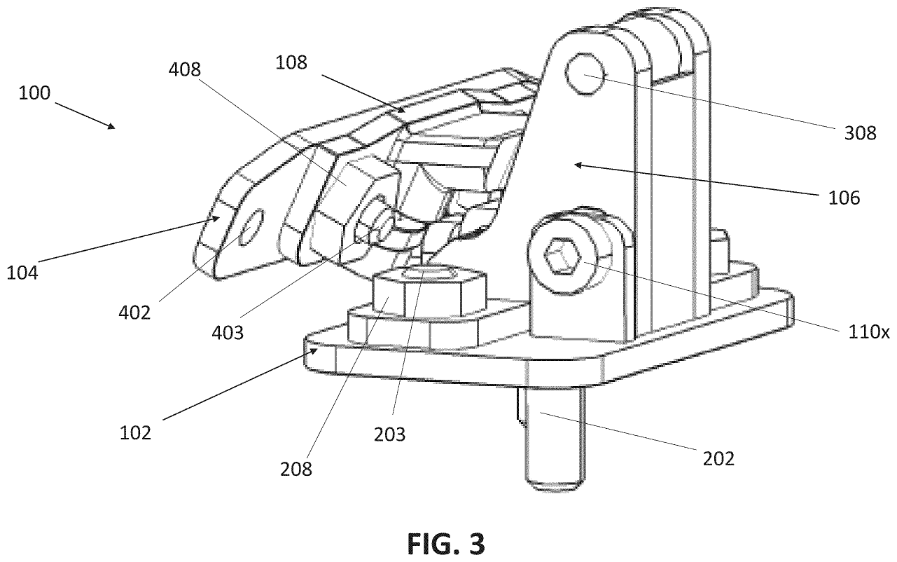

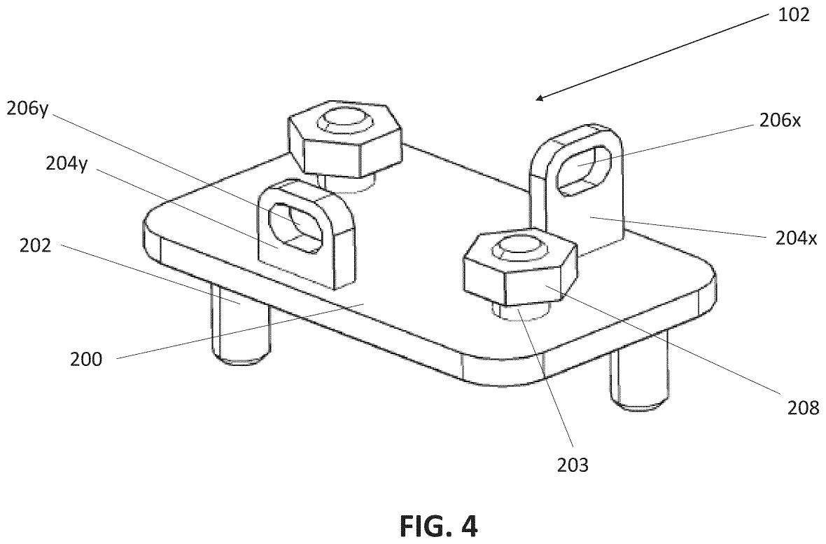

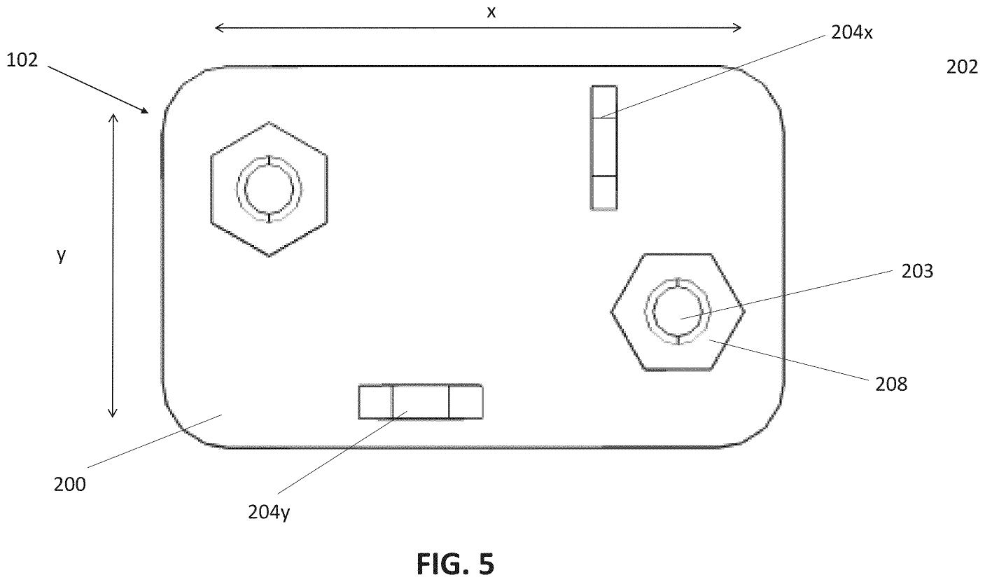

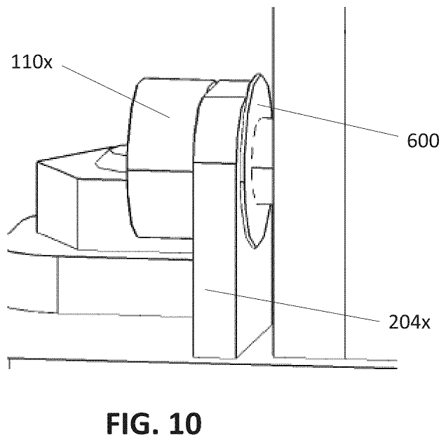

Referring to FIGS. 4-5, the first mounting plate 102 contains a substantially flat, planar body 200 configured to be mounted flush against the automobile body. The mounting of the first mounting plate 102 to the automobile body may be by adhesive, welding, or fasteners (e.g., screws, nuts/bolts, rivets, etc.). In certain embodiments, at least two fasteners 202 are used to mount the first mounting plate 102 to the automobile body. The fasteners 202 may be welded to the mounting plate 102 and configured to mount the mounting plate 102 to the automobile body. The planar body 200 contains mounting posts 203 extending perpendicularly from the plane of the planar body 200 for mounting of the first hinge member 106 thereon (as noted below, these mounting posts 203 may be replaced by bolts). The mounting posts 203 may be threaded to accept nuts 208 for holding the first hinge member 106 against the planar body 200. Additionally, the planar body 200 contains adjustment tabs 204x and 204y extending perpendicularly from the planar body 200 in the same direction as the mounting posts 203. The first adjustment tab 204x contains an oval through opening 206x for passing of an adjustment screw 110x therethrough (see FIG. 3). The opening 206x has a center axis in the x-direction, and a major axis in the y-direction orthogonal to the x-direction (both the x- and y-directions are parallel to the major plane of the planar body 200). The second adjustment tab 204y contains an oval through opening 206y for passing of an adjustment screw 110y (see FIG. 2) therethrough. The opening 206y has a center axis in the y-direction, and a major axis in the x-direction. The head of each the adjustment screws 206x and 206y is retained adjacent to its respective adjustment tab 204x or 204y, so that the head cannot back away from the adjustment tab 204x or 204y. In a preferred embodiment, as shown in FIG. 10, a lock ring 600 is used to retain the head of the adjustment screw 110x against the adjustment tab 204x. The lock ring 600 clips to the shaft of the adjustment screw 110x on the side of the adjustment tab 204x, such that the head of the adjustment screw 110x and the locking ring 600 are on opposing sides of the adjustment tab 204x. That way, the locking ring 600 prevents the head of the adjustment screw 110x from backing away from the adjustment tab 204x. A similar locking ring may also be used for the other adjustment screws 110y and 110z (described below).

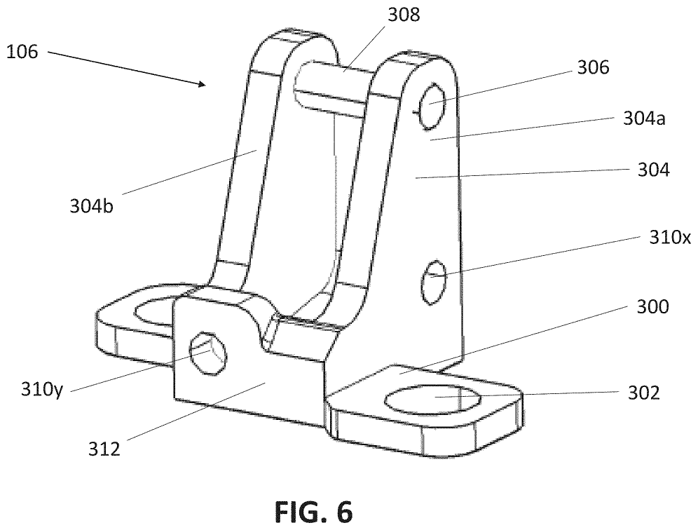

Referring to FIG. 6, the first hinge member 106 contains a base 300 and a hinge arm 304. The base 300 is configured to be mounted adjacent to and in contract with the first mounting plate 102. The base 300 contains holes 302 that are in registry and aligned with the mounting posts 203 on the first mounting plate 102, so that the mounting posts 203 can pass therethrough when the base 300 is placed against the first mounting plate 102. Nuts 208 are then used to secure the hinge member 106 to the first mounting plate 102. It is important that the holes 302 are slightly larger than the mounting posts 203, so that adjustments can be made as described below. In certain embodiments, the diameter of the holes 302 are about 4 to about 8 mm, or about 5 mm to about 8 mm larger than the diameter of the mounting posts 203. The diameter of the hole 302 depends on the adjustability designed into the first hinge member 106. For example, if the adjustability is ±2.5 mm, then the holes 302 are about 5 mm larger than the mounting posts 203. Likewise, for an adjustability of ±4 mm, then the diameter of the holes 302 are about 8 mm larger than the diameter of the mounting posts 203. The first hinge member 106 also contains a hinge arm 304 extending perpendicularly from the base 300. The hinge arm 304 may contain two arm members 304a and 304b as illustrated in the drawings, but may also be effectively designed with a single arm member. The distal end of the hinge arm 304 (the end farthest away from the base 300) contains a hole 306 configured to accept a shaft 308 therethrough. The shaft 308 is configured to hingely connect the first hinge member 106 to the second hinge member 108 (as described below). The hinge arm 304 contains a threaded hole 310x that is in registry and aligned with the opening 206x on the first mounting plate 102, when the first hinge member 106 is properly positioned on the first mounting plate 102. The first hinge member 106 also contains a wall 312 rising perpendicularly from the base 300 and facing a direction perpendicularly to the hinge arm 304. The wall 312 contains a threaded hole 310y that is in registry and aligned with the opening 206y on the first mounting plate 102.

To attach the first hinge member 106 to the first mounting plate 102, the base 300 of the first hinge member 106 is positioned against the planar body 200 of the first mounting plate 102, such that the mounting posts 203 of the first hinge member 106 passes through the holes 302 (see FIGS. 1-3). Nuts 208 are then used to secure the first hinge member 106 to the first mounting plate 102 (see FIGS. 1 and 2). Although mounting posts 203 and nuts 208 are described and shown in the drawings, it may be possible to use bolts/nuts to attach the first hinge member 106 to the first mounting plate 102. In that case, holes are located in the planar body 200 where the mounting posts 203 are shown. Bolts are then placed through the holes to substitute for the mounting posts 203. When the nuts/bolts are used, appropriate water tight gaskets should be used to prevent water seepage. Adjustment screw 110x is then placed through opening 206x and threadedly engaged to hole 310x (screwed into hole 210x) (see FIG. 3). Adjustment screw 110y is then placed through opening 206y and threadedly engaged to hole 310y (see FIG. 2). The adjustment screws 110x and 110y are used to make adjustments to the position of the first hinge member 106 relative to the first mounting plate 102 in approximately the x- and y-directions, respectively. Because the heads of the adjustment screws 110x and 110y are retained against their respective adjustment tabs 204x and 204y, e.g. by the locking ring 600, the turning of the screws 110x and 110y moves only the first hinge member 106 relative to the first mounting plate 102, when the nuts 208 are loosened.

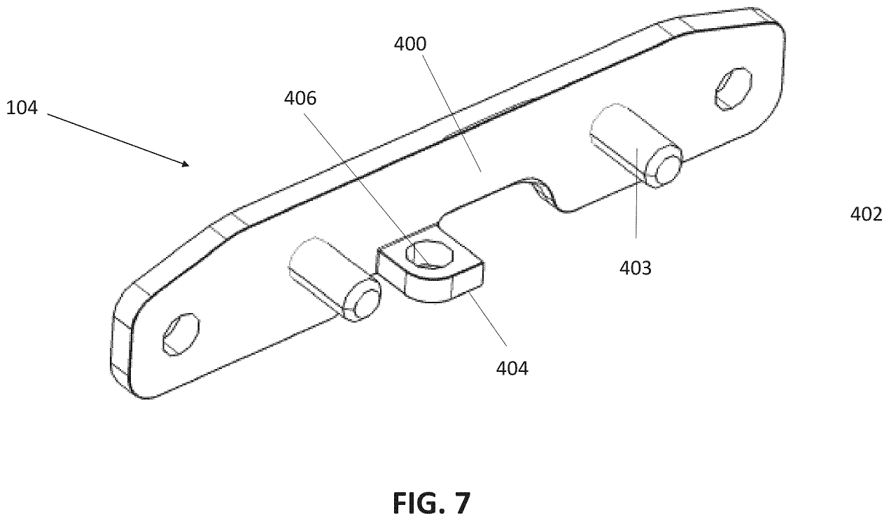

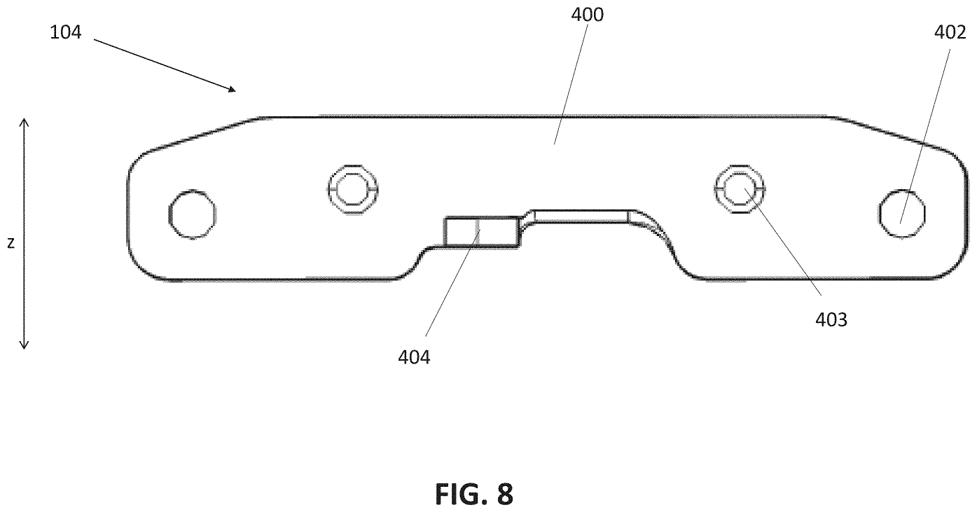

Referring to FIGS. 7-8, the second mounting plate 104 contains a substantially flat, planar body 400 configured to be mounted flush against the tailgate. The mounting of the second mounting plate 104 to the tailgate may be by adhesive, welding, or fasteners (e.g., screws, nuts/bolts, rivets, etc.). In certain embodiments, at least two fasteners are used to mount the second mounting plate 104 to the tailgate. The fasteners are place through holes 402 to mount the second mounting plate 104 to the tailgate. The planar body 400 contains one or more mounting posts 403 for mounting of the second hinge member 108 to the second mounting plate 104 (as noted below, the mounting post 403 may be replaced with nut/bolt similar to that disclosed above for the first mounting plate 102). The planar body 400 further contains an adjustment tab 404 extending perpendicularly from the planar body 400. The adjustment tab 404 contains an opening 406 for passing of an adjustment screw 110z (see FIG. 2) therethrough. The opening 406 has a center axis approximately in the z-direction (see FIG. 8). Like adjustment screws 110x and 110y, the adjustment screw 110z is also retained on its respective adjustment tab 404, e.g., by a lock ring 600, and prevented from backing therefrom.

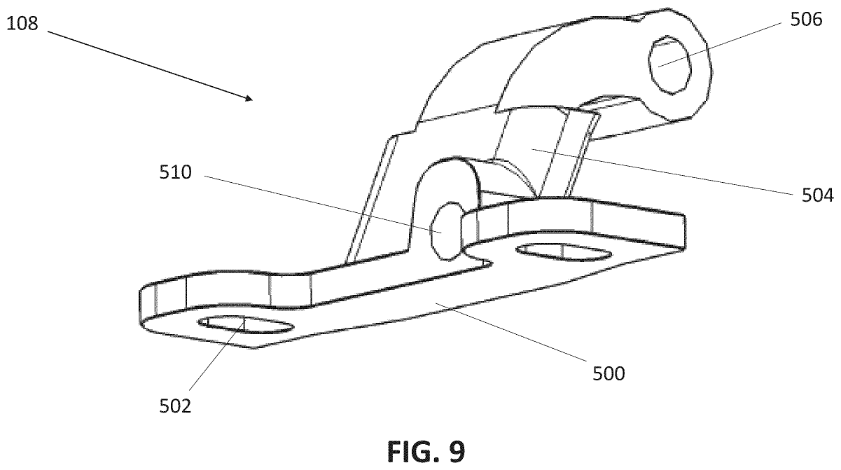

Referring to FIG. 9, the second hinge member 108 contains a base 500 and a hinge arm 304. The base 500 is configured to be mounted adjacent to and in contract with the second mounting plate 104. The base 500 contains holes 502 that are in registry and aligned with the mounting posts 203 on the second mounting plate 104, so that the mounting posts 203 can pass there through when the base 500 is placed against the second mounting plate 104. Nuts 408 threadedly engaging the mounting posts 203 can be used to secure the second hinge member 108 to the second mounting plate 104. It is important that the holes 502 are slightly larger than the bolts, so that fine adjustments can be made as described below. The difference between the size of the holes 502 and the size of the mounting posts 203 depends on the desired adjustability of the second hinge member 108 similar to that discussed above for the first hinge member 106. The second hinge member 108 also contains a hinge arm 504 extending away from the base 500. The distal end of the hinge arm 504 (the end farthest away from the base 500) contains a hole 506 configured to accept the shaft 308 there through. The shaft 308 is configured to hingely connect the second hinge member 108 to the first hinge member 106 (as described below). The proximal end of the hinge arm 504 (the end adjacent to the base 500) contains a threaded hole 510 that is in registry and aligned with the opening 406 on the second mounting plate 104, when the second hinge member 108 is properly positioned on the second mounting plate 104. In an embodiment, the hinge arm 504 may form a curve, e.g. a quarter circular curve, as it extends away from the base 500. The hinge arm 504, however, may be of different shapes as long as it does not interfere with the opening or closing of the tailgate.

To attach the second hinge member 108 to the second mounting plate 104, the base 500 of the second hinge member 108 is positioned against the planar body 400 of the second mounting plate 104, such that the holes 502 of the second hinge member 108 aligns with the mounting posts 403 of the second mounting plate 104 (see FIG. 3). Threaded engagement of nuts 408 with the mounting posts 403 are then used to secure the second hinge member 108 to the second mounting plate 104 (see FIG. 3). Although nuts 408 and mounting posts 403 are described and shown in the drawings, it may be possible to use bolts/nuts to attach the second hinge member 108 to the second mounting plate 104. In that case, holes are located in the planar body 400 where the mounting posts 403 are shown. Bolts are then placed through the holes to substitute for the mounting posts 403. When the nuts/bolts are used, appropriate water tight gaskets should be used to prevent water seepage. Adjustment screw 110z is then placed through opening 406 and threadedly engaged to hole 510 on the second hinge member 108 (see FIG. 2). The adjustment screws 110z can be used to make adjustments to the position of the second hinge member 108 in approximately the z-direction. Because the adjustment screw 110z is prevented from backing away for its respective adjustment tab 404, e.g. by the locking ring 600, the turning of the adjustment screw 110z moves the second hinge member 108 relative to the second mounting plate 104, when the nuts 408 are loosened.

To complete the hinge assembly 100, the distal ends of the first and second hinge members 106 and 108 are hingely connected by the shaft 308. The shaft 308 is placed through the hole 306 of the first hinge member 106 and the hole 506 of the second hinge member 108. The holes 306 and 506 are sufficiently sized to allow the first and second hinge members 106 and 108 to rotate around the shaft 308, thereby allowing for hinging movement between the first and second hinge members 106 and 108. When the hinge assembly 100 is in the closed position, the x-, y-, and z-directions are approximately orthogonal to each other.

The parts of the hinge assembly 100 may be made from metals and/or polymeric materials. For example, the hinge assembly 100 is made from steel and/or aluminum. The parts of the hinge assembly 100 may be made using techniques known in the art, such as, but not limited to, forging, molding, machining, laser shaping, stereo lithography, sintering, or combinations thereof.

The hinge assembly 100 is used to attach a tailgate to the body of an automobile. In certain embodiments, at least two hinge assemblies 100 are used to attach the tailgate. The first mounting plate 102 is attached directly to the body of the automobile, e.g. by fasteners 202; and the second mounting plate 103 is attached directly to the tailgate, e.g. by fasteners 402. Once the tailgate is roughly attached to the body of the automobile by the hinge assembly (or assemblies), fine adjustment of the position of the tailgate may be accomplished through the adjustment screws 110x, 110y, and 110z. The adjustment screws 110x, 110y, and 110z are retained on their respective adjustment tabs 204x, 204y, and 404, such that the screws are allowed to rotate around their center axes, but do not substantially move in the direction of the center axes and cannot back away from their respective adjustment tabs 204x, 204y, and 404. To make the adjustments, the nuts 208 (holding the first hinge member 106 to the first mounting plate 102) and 408 (holding the second hinge member 108 to the second mounting plate 104) are loosened. The loosened nuts 208 and 408 allow the hinge members 106 and 108 to “float” on their respective mounting plates 102 and 104. The adjustment screws 110x, 110y, and 110z are then used to adjust the position of the hinge members 106 and 108 in approximately the x-, y-, and z-directions, respectively; thereby, adjusting the position of the tailgate relative to the automobile body. Depending on the desired adjustment, each of adjustment screws 110x, 110y, and 110z may be turn to advance into its respective threaded holes 310x, 310y, or 510, respectively, or may be turn to back out (though not completely) of its respective threaded holes 310x, 310y, or 510. Because the screws are 110x, 110y, and 110z are retained on their respective adjustment tabs 204x, 204y, and 404, as described above, the rotation of the screw 110x or 110y moves the first hinge member 106 toward or away from the respective adjustment tabs 204x or 204y, and the rotation of the screw 110z moves the second hinge member 108 toward or away from the respective adjustment tab 404.

The hinge assembly 100 may be engineered and used for attaching any tailgate to an automobile. The tailgate may typically be used on a station wagon, a sports utility vehicle (SUV), or a truck. The tailgate may be opened by lifting the bottom of the tailgate away from the automobile body.

Although certain presently preferred embodiments of the invention have been specifically described herein, it will be apparent to those skilled in the art to which the invention pertains that variations and modifications of the various embodiments shown and described herein may be made without departing from the spirit and scope of the invention.

What is claimed is:

1. A hinge assembly comprising
a. a first mounting plate;
b. a first hinge member attached to the first mounting plate;
c. a second mounting plate;
d. a second hinge member attached to the second mounting plate and hingely connected to the first hinge member;
e. a first adjustment screw positioned to adjust the position of the first hinge member on the first mounting plate in the x-direction;
f. a second adjustment screw positioned to adjust the position of the first hinge member on the first mounting plate in the y-direction; and
g. a third adjustment screw positioned to adjust the position of the second hinge member on the second mounting plate in the z-direction,
wherein the x- and y-directions are in a plane parallel to the first mounting plate, and the x-, y-, and z-directions are approximately orthogonal to each other when the hinge assembly is in a closed position.

2. The hinge assembly of claim 1, wherein the first mounting plate comprises
i. a substantially flat, planar body containing a mounting means for the first hinge member,
ii. a first adjustment tab extending perpendicularly away from the planar body and having a first opening thereon, the first opening has an oval shape, a center axis in the x-direction, and a major axis in the y-direction,
iii. a second adjustment tab extending perpendicularly away from the planar body and having a second opening thereon, the second opening has an oval shape with a center axis in the y-direction and a major axis in the x-direction.

3. The hinge assembly of claim 2, wherein the first hinge member comprises a base mounted to the first mounting plate and a hinge arm extending perpendicularly from the base, the hinge arm containing a first threaded hole in alignment with the first opening, the first adjustment screw passes through the first opening and thread engages the first threaded hole.

4. The hinge assembly of claim 3, wherein the first hinge member further comprises a wall extending perpendicularly from the base and containing a second threaded hole in alignment with the second opening, the second adjustment screw passes through the second opening and thread engages the second threaded hole.

5. The hinge assembly of claim 3, wherein the distal end of the hinge arm contains a hole, a shaft passing through the hole hingely connects the first hinge member to the second hinge member.

6. The hinge assembly of claim 3, wherein the base of the first hinge member is mounted to the first mounting plate by bolts/nuts, or mounting posts on the first mounting plate and nuts.

7. The hinge assembly of claim 1, wherein the second mounting plate comprises
i. a substantially flat, planar body containing a mounting means for the second hinge member, and
ii. an adjustment tab extending perpendicularly away from the planar body and having an opening thereon, the opening having a center axis in the z-direction.

8. The hinge assembly of claim 7, wherein the second hinge member comprises a base mounted to the second mounting plate and a hinge arm extending perpendicularly from the base, the base containing a threaded adjustment hole in alignment with the opening on the second mounting plate, the third adjustment screw passes through the opening on the second mounting plate and threaded engages the threaded hole on the second hinge member.

9. The hinge assembly of claim 8, wherein the distal end of the hinge arm on the second hinge assembly contains a hole, a shaft passing through the hole hingely connects the second hinge member to the first hinge member.

10. The hinge assembly of claim 8, wherein the base of the second hinge member is mounted to the second mounting plate by bolts/nuts, or mounting posts on the second mounting plate and nuts.

11. The hinge assembly of claim 1, wherein the first mounting plate comprises holes configured for mounting the first mounting plate to an automobile body.

12. The hinge assembly of claim 1, wherein the second mounting plate comprises holes configured for mounting the second mounting plate to a tailgate.

13. The hinge assembly of claim 1, wherein the first mounting plate comprises
i. a substantially flat, planar body containing a mounting means for the first hinge member,
ii. a first adjustment tab extending perpendicularly away from the planar body and having a first opening thereon, the first opening has an oval shape a center axis in the x-direction and a major axis in the y-direction,
iii. a second adjustment tab extending perpendicularly away from the planar body and having a second opening thereon, the second opening has an oval shape with a center axis in the y-direction and a major axis in the x-direction;
wherein the first hinge member comprises
i. a first base mounted to the first mounting plate,
ii. a first hinge arm extending perpendicularly from the base, the first hinge arm containing a first threaded hole in alignment with the first opening, the first adjustment screw passes through the first opening and threadedly engages the first threaded hole, and
iii. a wall extending perpendicularly from the base and containing a second threaded hole in alignment with the second opening, the second adjustment screw passes through the second opening and threadedly engages the second threaded hole,
wherein the second mounting plate comprises
i. a substantially flat, planar body containing a mounting means for the second hinge member,
ii. a third adjustment tab extending perpendicularly away from the planar body and having a third opening thereon, the third opening having a center axis in the z-direction,
wherein the second hinge member comprises
i. a second base mounted to the second mounting plate, the second base containing a third threaded hole in alignment with the third opening, the third adjustment screw passes through the third opening and threadedly engages the third threaded hole,
ii. a second hinge arm extending perpendicularly from the base.

14. The hinge assembly of claim 13, wherein the distal end of the first hinge arm contains a hole, and the distal end of the second hinge arm contains a hole, a shaft positioned through the holes at the ends of the first and second hinge arms hingely connects the first and second hinge members.

15. The hinge assembly of claim 13, wherein the first hinge member is mounted to the first mounting plate or the second hinge member is mounted to the second mounting plate by bolts/nuts, or mounting posts and nuts.

16. An automobile comprising the hinge assembly of claim 1.

17. The automobile of claim 16, further comprising a tailgate, wherein the first mounting plate is mounted to a body of the automobile and the second mounting plate is mounted to the tailgate.

18. A method for installing a tailgate on an automobile comprising the steps of
a. providing the hinge assembly of claim 1;
b. mounting the first mounting plate to the body of the automobile; and
c. mounting the second plate to the tailgate.

19. The method of the claim 18, further comprising the step of adjusting the position of the door on the automobile by using the first, second, and/or third adjustment screw.

20. The method of claim 18, wherein steps b or c is accomplished by using adhesive, welding, and/or fasteners.
